(19) United States
(12) Patent Application Publication
(10) Pub. No.: US 2010/0128048 A1
(43) Pub. Date: May 27, 2010

(54) COMMODITY SALES DATA PROCESSING APPARATUS AND CONTROL METHOD THEREFOR

(75) Inventors: Masaaki Makino, Kanagawa (JP); Takayuki Kumagawa, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/623,606

(22) Filed: Nov. 23, 2009

(30) Foreign Application Priority Data
Nov. 26, 2008 (JP) 2008-301375

(51) Int. Cl. G09G 5/00; G09G 5/30

(52) U.S. Cl. 345/581; 345/204; 345/156

(57) ABSTRACT

A commodity sales data processing apparatus including a display unit configured to display various kinds of information includes an angle-of-field setting unit configured to set an angle of field of a display screen of the display unit to a first angle of field or a second angle of field narrower than the first angle of field. An angle-of-field control section of the commodity sales data processing apparatus causes the angle-of-field setting unit to operate according to a processing state of the commodity sales data processing apparatus and set the angle of field of the display screen of the display unit to the first angle of field or the second angle of field.

### CROSS-REFERENCE TO RELATED APPLICATION

This application is based upon and claims the benefit of priority from the prior Japanese Patent Application No. 2008-301375, filed Nov. 26, 2008, the entire contents of which are incorporated herein by reference.

### TECHNICAL FIELD

The present invention relates to a commodity sales data processing apparatus used for checkout processing in commodity sales stores such as a supermarket and a convenience store and a control method therefor.

### BACKGROUND

In the past, a commodity sales data processing apparatus such as a POS (Point Of Sales) terminal is used for checkout processing in commodity sales stores such as a supermarket and a convenience store. The commodity sales data processing apparatus includes an operator side display that displays processing content to an operator, a customer side display that displays checkout information and the like to a customer, a scanner that reads barcodes attached to commodities, a keyboard that receives the input of characters and the like by the depression of operation keys, and a card reader that reads information stored in a magnetic card such as a credit card.

The operator side display is designed to have a wide angle of field to allow an operator to visually recognize displayed content even if an angle for viewing a screen changes because of the difference in height of operators, the slight difference in posture during work, or the like. It is a general practice to also design, taking into account display performed to aim at the effectiveness of advertising such as commercial videos, the customer side display to have a wide angle of field to allow a customer to visually recognize displayed content from various angles.

For example, when the settlement of a transaction is performed by using a credit card or a debit card or when a point card is used, personal information such as a credit card number, age, sex, a name, the number of points of a customer is displayed on the operator side display. Therefore, from the viewpoint of protection of the personal information, some store takes measures of bonding a film having a very small louver layer to the surface of the operator side display to narrow the angle of field.

As a technique for protecting the personal information displayed on the screen in the same manner, a display apparatus disclosed in JP-A-2006-259930 is known. This display apparatus includes peep preventing means, an image photographing device, and counting means for detecting faces images with the image photographing device and counting the number of detected face images. When plural face images are counted by the counting means, the peep preventing means is caused to operate.

As described in JP-A-2008-107404, a display apparatus is developed that can electrically adjust an angle of field using a transparent-scattering switching element such as PNLC (Polymer Network Liquid Crystal) having polymer dispersion liquid crystal nipped by substrates provided with transparent electrodes.

In the display apparatus disclosed in JP-A-2008-107404, the refractive indexes of a polymer chain and the polymer dispersion liquid crystal are the same in a state in which voltage is applied between the transparent electrode pair. The transparent-scattering switching element changes to a transparent state. In this state, since an emission angle range of light emitted from a light source is, limited, an angle of field of a display screen is narrowed. On the other hand, in a state in which voltage is not applied between the transparent electrode pair, the refractive indexes of the polymer chain and the polymer dispersion liquid crystal are different. In this state, the light emitted from the light source scatters when the light passes through the transparent-scattering switching element. Therefore, since the emission angle range of the light emitted from the light source is expanded, the angle of field of the display screen is widened.

As explained above, when the film having the very small louver layer is bonded to the surface of the operator side display, there is a disadvantage that the angle of field is always narrow. Therefore, an operation screen becomes less easily seen to cause inconvenience in the operation of the commodity sales data processing apparatus. In the case of a display with a pressure sensitive touch panel bonded on a display screen to enable touch operation, input sensitivity of the touch panel falls.

Concerning the customer side display, since the effectiveness of advertising cannot be obtained if the angle of field is always narrow, the method of bonding the film having the very small louver layer cannot be adopted.

In the technique disclosed in JP-A-2006-259930, the peep preventing means is caused to operate according to only the number of face images shown on the image photographing device irrespectively of content displayed on the display screen. Therefore, the peep preventing means operates even when content that may be seen by anybody is only displayed.

### SUMMARY

The present invention has been devised in view of such circumstances and it is an object of the present invention to provide a commodity sales data processing apparatus that can automatically adjust an angle of field of a display screen of a display unit according to a processing state while keeping operability of the apparatus and appropriately prevent a peep and a control method therefor.

A commodity sales data processing apparatus according to an aspect of the present invention includes: a display unit configured to display various kinds of information; an angle-of-field setting unit configured to set an angle of field of a display screen of the display unit to a first angle of field or a second angle of field narrower than the first angle of field; and an angle-of-field control section configured to cause the angle-of-field setting unit to operate according to a processing state of the apparatus and set the angle of field of the display screen of the display unit to the first angle of field or the second angle of field.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an external perspective view of a commodity sales data processing apparatus according to a first embodiment of the present invention;

FIG. 2 is a block diagram of a control circuit of the commodity sales data processing apparatus according to the first embodiment;

FIG. 3 is a flowchart of angle-of-field switching processing for an operator side display according to the first embodiment;

FIG. 4 is a flowchart of angle-of-field switching processing for a customer side display according to the first embodiment; and

FIG. 5 is a flowchart of angle-of-field switching processing for an operator side display according to a second embodiment of the present invention.

### DETAILED DESCRIPTION

### First Embodiment

A first embodiment for carrying out the present invention is explained below with reference to the accompanying drawings.

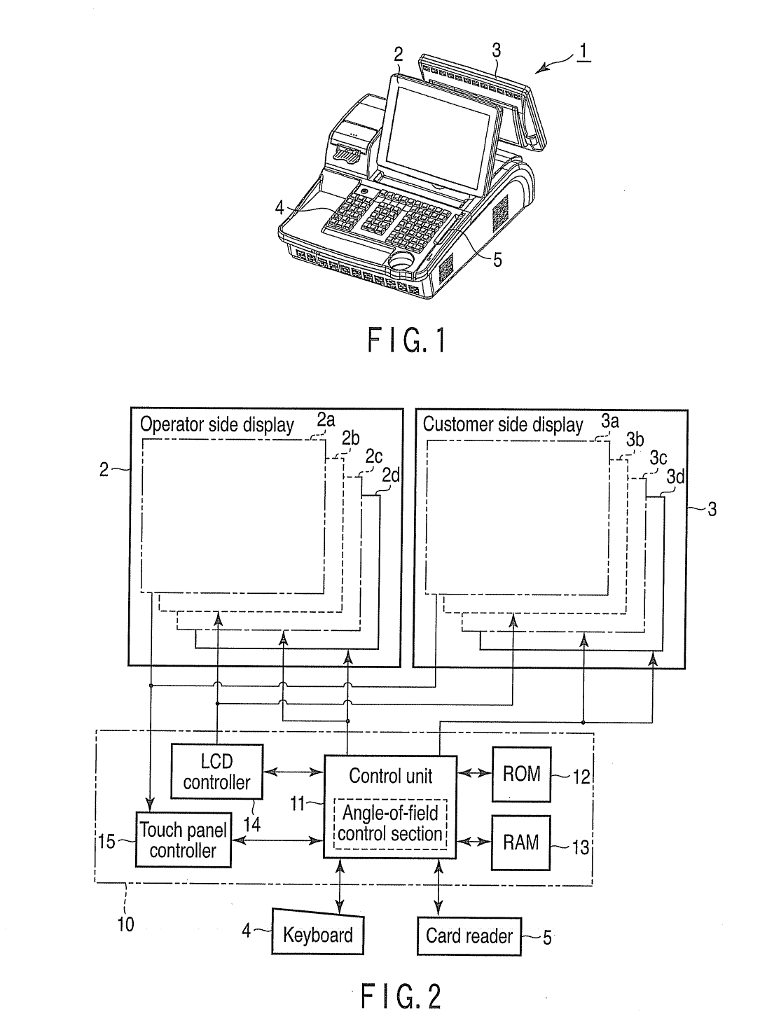

FIG. 1 is an external perspective view of a commodity sales data processing apparatus 1 according to this embodiment. The commodity sales data processing apparatus 1 includes an operator side display 2 and a customer side display 3 as display units according to this embodiment, a keyboard 4, and a card reader 5 as card reading means.

The operator side display 2 displays various kinds of information such as processing content to an operator. The customer side display 3 displays various kinds of commercial information such as advertisements of commodities and a store, event information, news, and the weather forecast, the price for a transaction, and the like to a customer. The operator side display 2 and the customer side display 3 respectively include touch panels on the surfaces of display screens. The operator can input information by touch-operating the display screens of the operator side display 2 and the customer side display 3.

The keyboard 4 includes various operation keys such as numeric keys for inputting numerical values, a cash total key for calculating a total amount of a transaction, a closing key for declaring the end of the transaction, and a card settlement key for declaring settlement by a credit card.

The card reader 5 reads information stored in magnetic cards such as a credit card, a debit card, and a point card that stores preferential points given to the customer.

A control circuit of the commodity sales data processing apparatus 1 is explained below. FIG. 2 is a block diagram of the control circuit of the commodity sales data processing apparatus 1. The control circuit is configured by connecting the operator side display 2, the customer side display 3, the keyboard 4, and the card reader 5 to a circuit 10 incorporated in a main body of the commodity sales data processing apparatus 1.

The circuit 10 is configured by connecting a ROM (Read Only Memory) 12, a RAM (Random Access Memory) 13, an LCD (Liquid Crystal Display) controller 14, and a touch panel controller 15 to a control unit 11 via bus lines such as an address bus and a data bus. The display screen of the operator side display 2 is configured by superimposing a touch panel 2a, an LCD panel 2b, a sheet polarizer 2c as an angle-of-field setting unit according to this embodiment, and a backlight system 2d, which have substantially the same sizes, in order from the top surface in a display direction. Like the operator side display 2, the customer side display 3 is configured by superimposing a touch panel 3a, an LCD panel 3b, a sheet polarizer 3c as the angle-of-field setting unit according to this embodiment, and a backlight system 3d, which have substantially the same sizes, in order from the top surface in the display direction.

The control unit 11 is main control means for the commodity sales data processing apparatus 1 including a CPU (Central Processing Unit) and a memory system. The ROM 12 has stored therein stationary information such as a computer program necessary for the operation of the commodity sales data processing apparatus 1. The RAM 13 forms storage areas for various kinds of work according to processing scenes. The LCD controller 14 includes a controller that controls image display on the LCD panel 2b and a controller that controls image display on the LCD panel 3b. The touch panel controller 15 includes a controller that detects a touch operation position on the touch panel 2a and a controller that detects a touch operation position on the touch panel 3a. The touch operation positions detected by the touch panel controller 15 are transmitted to the control unit 11. The backlight systems 2d and 3d are turned on or off according to the reception of a predetermined control signal from the control unit 11.

The sheet polarizers 2c and 3c include transparent-scattering switching elements such as PNLC. A predetermined voltage signal is applied to the entire sheet polarizers 2c and 3c according to the output of the predetermined control signal from the control unit 11.

In a state in which the voltage signal is not applied to the sheet polarizers 2c and 3c, lights emitted from the backlight systems 2d and 3d are diffused in the sheet polarizers 2c and 3c. The diffused lights pass through the LCD panels 2b and 3b. At this point, lights emitted from the screens of the operator side display 2 and the customer side display 3 are diffused not only in normal directions with respect to the screens but also in all directions. Therefore, fixed or higher luminance and a fixed or higher contrast ratio are maintained not only in the front directions but also in oblique directions of the screens. Displayed images on the operator side display 2 and the customer side display 3 can be visually recognized from a wide range. Such a state is hereinafter referred to as wide angle of field (first angle of field) state.

On the other hand, in a state in which the voltage signal is applied to the sheet polarizers 2c and 3c, the lights emitted from the backlight systems 2d and 3d travel straight in the LCD panels 2b and 3b without being diffused in the sheet polarizers 2c and 3c. At this point, the lights emitted from the screens of the operator side display 2 and the customer side display 3 are limited to only substantial normal directions with respect to the screens. Therefore, when the operator side display 2 and the customer side display 3 are viewed from the fronts, the luminance and the contrast of the display screens are maintained at degrees same as those obtained when the voltage is not applied. However, when the operator side display 2 and the customer side display 3 are viewed from oblique directions, the luminance markedly falls compared with that obtained when the operator side display 2 and the customer side display 3 are viewed from the fronts. Therefore, displayed images cannot be visually recognized. In the following explanation, a state in which the angle of field is narrow compared with the wide angle of field state in this way is referred to as narrow angle of field (second angle of field) state.

As a main function, the control unit 11 has an angle-of-field control section that causes the sheet polarizers 2c and 3c to operate according to a processing state of the commodity sales data processing apparatus 1 and set angles of field of the display screens of the operator side display 2 and the customer side display 3 to a wide angle of field or a narrow angle of field. In particular, the angle-of-field control section according to this embodiment causes the sheet polarizer 2c to operate and set the angle of field of the display screen of the operator side display 2 to the narrow angle of field when personal information is displayed on the operator side display 2. The angle-of-field control section causes the sheet polarizer 2c to operate and set the angle of field of the display screen of the operator side display 2 to the wide angle of field when the display of the personal information on the operator side display 2 ends. Further, the angle-of-field control section causes the sheet polarizer 3c to operate and set the angle of field of the display screen of the customer side display 3 to the narrow angle of field when any one of specific operation keys involving display of personal information on the customer side display 3 according to operation thereof among the operation keys of the keyboard 4 and the like is operated. The angle-of-field control section causes the sheet polarizer 3c to operate and set the angle of field of the display screen of the customer side display 3 to the wide angle of field when a series of processing involved in the operation of the specific operation key is completed.

Actions realized by the configuration explained above are explained below.

In this embodiment, the display screen of the operator side display 2 is usually in the wide angle of field state. When personal information such as a credit card number, age, sex, a name, and the number of points of a customer is displayed on the display screen of the operator side display 2, the display screen of the operator side display 2 is switched to the narrow angle of field state.

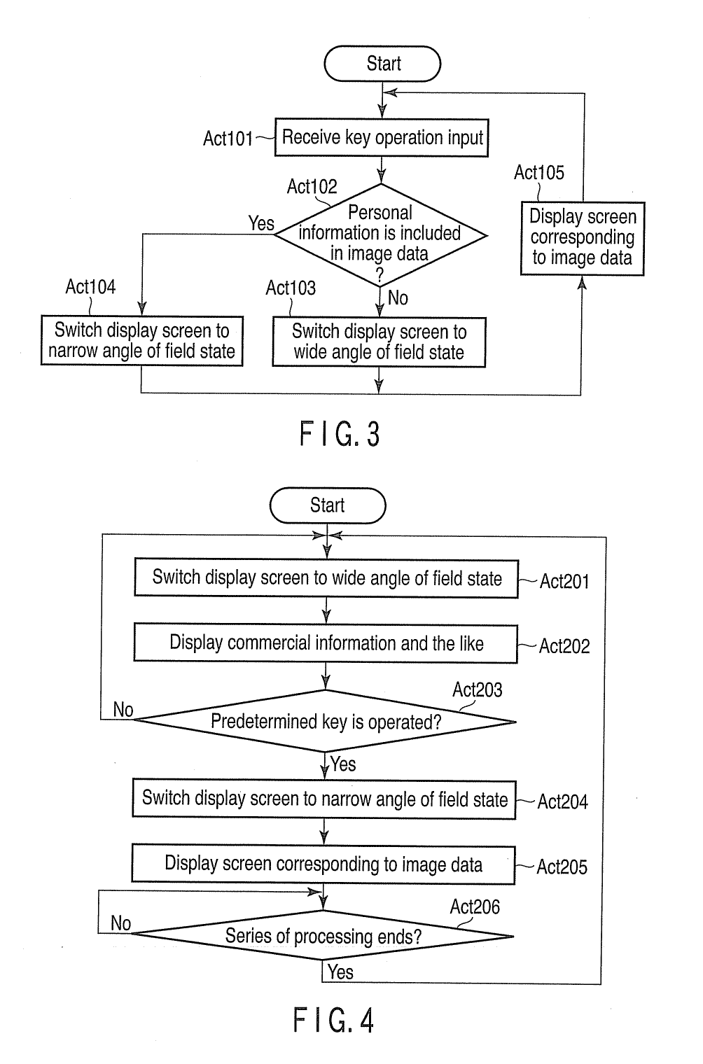

FIG. 3 is a flowchart of angle-of-field switching processing for the operator side display 2 executed by the control unit 11. This processing is executed on the basis of an operation program stored in the ROM 12.

First, the control unit 11 receives key operation input from the keyboard 4 (Act 101). When some key operation is performed to change a screen displayed on the operator side display 2, the control unit 11 creates image data that should be displayed on the operator side display 2. The control unit 11 determines whether personal information is included in the created image data (Act 102). For this determination, for example, types of information corresponding to the personal information are decided and stored in the ROM 12 in advance. The control unit 11 searches for information corresponding to the types in the image data. The control unit 11 determines that the personal information is not included in the image data if the corresponding information cannot be found. The control unit 11 determines that the personal information is included in the image data if at least one kind of the corresponding information is found.

As a result of determining whether the personal information is included in the image data in this way, if the control unit 11 determines that the personal information is not included in the image data (No in Act 102), the control unit 11 outputs a control signal indicating that the display screen of the operator side display 2 should be shifted to the wide angle of field state to the sheet polarizer 2c (Act 103). If the display screen of the operator side display 2 is currently in the wide angle of field state, the sheet polarizer 2c that receives this signal maintains the wide angle of field state. If the display screen of the operator side display 2 is in the narrow angle of field state, the sheet polarizer 2c stops the application of a predetermined voltage signal to the sheet polarizer 2c itself. The display screen of the operator side display 2 is switched to the wide angle of field state.

On the other hand, as a result of determining whether the personal information is included in the image data as explained above, if the control unit 11 determines that the personal information is included in the image data (Yes in Act 102), the control unit 11 outputs a control signal indicating that the display screen of the operator side display 2 should be shifted to the narrow angle of field state to the sheet polarizer 2c (Act 104). If the display screen of the operator side display 2 is currently in the narrow angle of field state, the sheet polarizer 2c that receives this signal maintains the narrow angle of field state. If the display screen of the operator side display 2 is in the wide angle of field state, the sheet polarizer 2c starts the application of the predetermined voltage signal to the sheet polarizer 2c itself. The display screen of the operator side display 2 is switched to the narrow angle of field state.

In this way, after switching the display screen of the operator side display 2 to the wide angle of field state or the narrow angle of field state, the control unit 11 outputs the image data to the LCD controller 14 (Act 105). The LCD controller 14 that receives the image data outputs a display signal based on the image data to the LCD panel 2b. The LCD panel 2b that receives the output of the display signal displays a screen according to the display signal. Thereafter, the processing in Act 101 to Act 105 is repeatedly executed. Specifically, while the personal information is displayed on the operator side display 2, the display screen is switched to the narrow angle of field state. When the displayed personal information is erased, the display screen is switched to the wide angle of field state.

In this embodiment, the display screen of the customer side display 3 is usually in the wide angle of field state in order to cause a wide range of customers to visually recognize commercial information and the like. According to the operation of any one of the specific operation keys, the display screen of the customer side display 3 is switched to the narrow angle of field state.

The specific operation keys are a ticket sales key for declaring the start of sales processing for various kinds of tickets, a home delivery key for starting reception processing for a home delivery service, and the like.

The specific operation keys include, besides the operation keys arranged on the keyboard 4, operation keys displayed on the display screen of the operator side display 2 or the customer side display 3. In other words, the keyboard 4, the operator side display 2, and the customer side display 3 function as an input unit according to this embodiment.

In the ticket sales processing, in order to cause a customer to confirm information concerning a ticket that the customer purchases, the ticket information is displayed on the customer side display 3, personal information such as a name, an address, and age of the customer is displayed on the customer side display 3, or an operation key for allowing the customer to select Yes or No is displayed to request the customer to confirm whether the ticket information and the personal information are correct. In the home delivery processing, an operation key for allowing the customer to select Yes or No is displayed to request the customer to confirm whether information concerning a sender and a destination is correct. The customer often does not desire others to visually recognize these kinds of information.

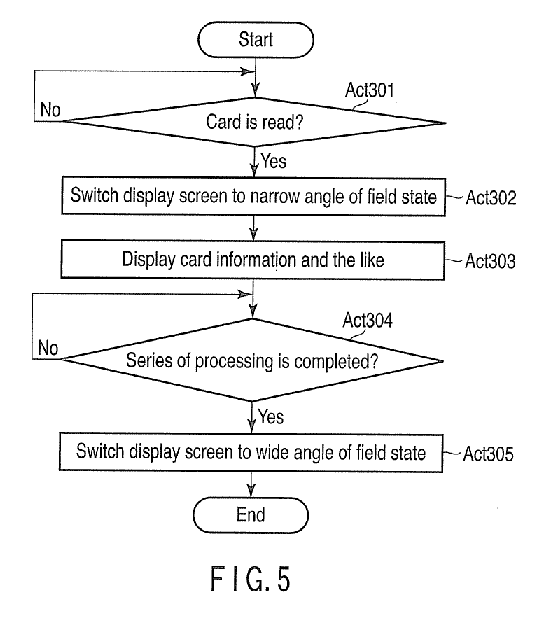

FIG. 4 is a flowchart of angle-of-field switching processing for the customer side display 3 executed by the control unit 11. This processing is executed on the basis of an operation program stored in the ROM 12.

First, the control unit 11 outputs a control signal indicating that the display screen of the customer side display 3 should be shifted to the wide angle of field state to the sheet polarizer 3c (Act 201). If the display screen of the customer side display 3 is currently in the wide angle of field state, the sheet polarizer 3c that receives this signal maintains the wide angle of field state. If the display screen of the customer side display 3 is in the narrow angle of field state, the sheet polarizer 3c stops the application of the predetermined voltage signal to the sheet polarizer 3c itself. The display screen of the customer side display 3 is switched to the wide angle of field state.

Subsequently, the control unit 11 outputs image data for displaying commercial information and the like on the customer side display 3 to the LCD controller 14 (Act 202). When the LCD controller 14 receives the image data, the LCD controller 14 outputs a display signal based on the image data to the LCD panel 3b. When the LCD panel 3b receives the output of the display signal from the LCD controller 14, the LCD panel 3b displays a screen according to the received display signal. As the commercial information and the like, information delivered from a store server connected via a LAN (Local Area Network) is received and stored in storing means (not shown) such as a hard disk drive.

The control unit 11 determines whether any one of the specific operation keys is operated (Act 203). If the control unit 11 determines that none of the specific operation keys is operated (No in Act 203), the control unit 11 continues the display of the commercial information and the like while keeping the display screen of the customer side display 3 in the wide angle of field state. On the other hand, if the control unit 11 determines that any one of the specific operation keys is operated (Yes in Act 203), the control unit 11 outputs a control signal indicating that the display screen of the customer side display 3 should be shifted to the narrow angle of field state to the sheet polarizer 3c (Act 204). If the display screen of the customer side display 3 is currently in the narrow angle of field state, the sheet polarizer 3c that receives this signal maintains the narrow angle of field state. If the display screen of the customer side display 3 is in the wide angle of field state, the sheet polarizer 3c starts the application of the predetermined voltage signal to the sheet polarizer 3c itself. The display screen of the customer side display 3 is switched to the narrow angle of field state.

After switching the display screen of the customer side display 3 to the narrow angle of field state in this way, the control unit 11 outputs image data corresponding to processing started by the key operation to the LCD controller 14 (Act 205). The LCD controller 14 that receives the image data outputs a display signal based on the image data to the LCD panel 3b. The LCD panel 3b that receives the output of the display signal displays a screen according to the display signal. Thereafter, the control unit 11 waits for completion of a series of processing started by the key operation (Act 206). If the processing is completed (Yes in Act 206), the control unit 11 returns to the operation in Act 201 and displays the commercial information and the like on the customer side display 3 again.

As explained above, the angle of field of the display screen of the operator side display 2 in this embodiment is usually set to the wide angle of field. However, when personal information is included in image data to be displayed, the angle of field is automatically switched to the narrow angle of field. Therefore, it is possible to prevent a peed only when necessary without requiring special operation. The angle of field of the display screen of the operator side display 2 is set to the wide angle of field when personal information is not displayed. Therefore, since it is not difficult to visually recognize displayed content, sufficient operability is kept.

The angle of field of the display screen of the customer side display 3 is usually set to the wide angle of field. However, the angle of field is switched to the narrow angle of field according to the operation of any one of the specific operation keys. Therefore, when processing involving display of personal information on the customer side display 3 or processing involving display for requesting a customer to select Yes or No is executed, the angle of field of the display screen is surely set to the narrow angle of field and privacy of the customer protected.

The angle of field of the display screen of the customer side display 3 is set to the wide angle of field unless any one of the specific operation keys is operated. Therefore, the customer can easily visually recognize commercial information and the like displayed while the angle of field is set to the wide angle of field. In other words, the effectiveness of advertising by the screen display on the customer side display 3 does not fall.

### Second Embodiment

A second embodiment of the present invention is explained below with reference to the accompanying drawings.

The commodity sales data processing apparatus 1 according to this embodiment is different from the commodity sales data processing apparatus 1 according to the first embodiment in that, when a magnetic card such as a credit card, a debit card, or a point card is read by the card reader 5, the angle of field of the display screen of the operator side display 2 is set to the narrow angle of field. Components and the like of the commodity sales data processing apparatus 1 are the same as those in the first embodiment. Therefore, the same components are denoted by the same reference numerals and signs and explanation of the components is omitted.

As in the first embodiment, the control unit 11 according to the second embodiment has an angle-of-field control section that causes the sheet polarizers 2c and 3c to operate according to a processing state of the commodity sales data processing apparatus 1 and set angles of field of the display screens of the operator side display 2 and the customer side display 3 to the wide angle of field or the narrow angle of field. In particular, the angle-of-field control section according to this embodiment causes the sheet polarizer 2c to operate and set the angle of field of the display screen of the operator side display 2 to the narrow angle of field when a card is read by the card reader 5. The angle-of-field control section causes the sheet polarizer 2c to operate and set the angle of field of the display screen of the operator side display 2 to the wide angle of field when a series of processing involved in the card reading ends.

FIG. 5 is a flowchart of angle-of-field switching processing for the operator side display 2 executed by the control unit 11. This processing is executed on the basis of an operation program stored in the ROM 12 using, as a trigger, the operation of a card key for declaring reading of a magnetic card provided in the keyboard 4.

First, the control unit 11 waits for reading of a magnetic card by the card reader 5 (Act 301). If the magnetic card is slid through the card reader 5 and read (Yes in Act 301), the control unit 11 outputs a control signal indicating that the display screen of the operator side display 2 should be shifted to the narrow angle of field state to the sheet polarizer 2c (Act 302). If the display screen of the operator side display 2 is currently in the narrow angle of field state, the sheet polarizer 2c that receives this signal maintains the narrow angle of field state. If the display screen of the operator side display 2 is in the wide angle of field state, the sheet polarizer 2c starts the application of the predetermined voltage signal to the sheet polarizer 2c itself. The display screen of the operator side display 2 is switched to the narrow angle of field state.

After switching the display screen of the operator side display 2 to the narrow angle of field state in this way, the control unit 11 creates image data for displaying information read from the magnetic card by the card reader 5 and outputs the image data to the LCD controller 14 (Act 303). The LCD controller 14 that receives the image data outputs a display signal based on the image data to the LCD panel 2b. The LCD panel 2b that receives the output of the display signal displays a screen according to the display signal. The information displayed at this point is a credit card number and a name and the like of a card owner if the magnetic card read by the card reader 5 is, for example, a credit card. The information is a name of a customer, the number of points given to the customer, and the like if the magnetic card is a point card.

After the information stored in the magnetic card is displayed on the operator side display 2 in this way, the control unit 11 waits for completion of a series of processing involved in the reading of the card (Act 304). If the series of processing is completed (Yes in Act 304), the control unit 11 outputs a control signal indicating that the display screen of the operator side display 2 should be shifted to the wide angle of field state to the sheet polarizer 2c (Act 305). If the display screen of the operator side display 2 is currently in the wide angle of field state, the sheet polarizer 2c that receives this signal maintains the wide angle of field state. If the display screen of the operator side display 2 is in the narrow angle of field state, the sheet polarizer 2c stops the application of the predetermined voltage signal to the sheet polarizer 2c itself. The display screen of the operator side display 2 is switched to the wide angle of field state. The control unit 11 ends the angle-of-field switching processing.

As explained above, the commodity sales data processing apparatus 1 according to this embodiment switches the angle of field of the display screen of the operator side display 2 according to the reading of the magnetic card by the card reader 5. Therefore, when personal information is displayed on the display screen of the operator side display 2 on the basis of the information stored in the magnetic card, the display screen is surely switched to the narrow angle of field state. Therefore, probability of peeping of the personal information is reduced and privacy of the customer is sufficiently protected.

When the series of processing executed according to the reading of the magnetic card is completed, the display screen of the operator side display 2 is automatically switched to the wide angle of field state. In this way, timing for the switching to the narrow angle of field state is limited to the time when processing with high probability of personal information display is executed. Therefore, it is possible to minimize a fall in visibility of a displayed image and keep sufficient operability as in the first embodiment.

### MODIFICATIONS

A processing state of the commodity sales data processing apparatus 1 in which the display screens of the operator side display 2 and the customer side display 3 should be switched to the narrow angle of field state is not limited to the time when personal information is displayed on the display screens, the time when any one of the specific operation keys is operated, and the time when a magnetic card is read by the card reader 5. Besides, the display screens of the operator side display 2 and the customer side display 3 may be switched to the narrow angle of field state when processing for displaying information that is inappropriate for indefinite people to be able to see on the operator side display 2 or the customer side display 3 is performed.

In the above explanation of the embodiments, the sheet polarizer 2c or the sheet polarizer 3c is arranged between the LCD panel 2b and the backlight system 2d or between the LCD panel 3b and the backlight system 3d. However, an arrangement position of the sheet polarizers 2c and 3c is not limited to this. For example, the sheet polarizer 2c may be arranged between the touch panel 2a and the LCD panel 2b or the sheet polarizer 3c may be arranged between the touch panel 3a and the LCD panel 3b.

In the above explanation of the embodiments, the LCD is adopted for the operator side display 2 and the customer side display 3. However, a display system of the displays is not limited to the LCD. Other display elements such as an FED (Field Emission Display), a plasma display, an EL (Electro Luminescence) display, and a CRT (Cathode Ray Tube) may be adopted.

In the above explanation of the embodiments, the angles of field of the display screens of the operator side display 2 and the customer side display 3 are set to the wide angle of field or the narrow angle of field. However, the angles of field of the display screens of the operator side display 2 and the customer side display 3 can be set in a larger number of stages. For example, the sheet polarizers 2c and 3c that can set the angle of field in three stages including an intermediate angle of field between the narrow angle of field and the wide angle of field in addition to the narrow angle of field and the wide angle of field are adopted. The angles of field of the display screens of the operator side display 2 and the customer side display 3 are controlled to be set to any one of the angles of field in the three stages according to a processing state of the commodity sales data processing apparatus 1 such as the time when personal information is displayed on the display screens, the time when any one of the specific operation keys is operated, and the time when a magnetic card is read by the card reader 5. It is also conceivable to perform control to set the angles of field narrower as confidentiality of information displayed on the display screens of the operator side display 2 and the customer side display 3 is higher. It is possible to perform detailed setting of the angles of field more corresponding to a processing state by adopting such a configuration.

In the first embodiment, the display screen of the operator side display 2 is set to the narrow angle of field state when personal information is included in image data to be displayed on the operator side display 2. However, the same processing may be applied to the customer side display 3. Similarly, in the first embodiment, the display screen of the customer side display 3 is set to the narrow angle of field state when any one of the specific operation keys is operated. However, the same processing may be applied to the operator side display 2.

In the second embodiment, the display screen of the operator side display 2 is switched to the narrow angle of field state when a magnetic card is read by the card reader 5. However, the same processing may be applied to the customer side display 3.

In the second embodiment, the display screen of the operator side display 2 may be switched to the narrow angle of field state according to, instead of reading of a magnetic card by the card reader 5, reading of information from an electronic money medium of an apparatus having a function similar to card settlement processing, for example, a cellular phone having an electronic money function. In this case, a reading unit that reads information from the electronic money medium is provided in the commodity sales data processing apparatus 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A commodity sales data processing apparatus comprising:
a display unit configured to display various kinds of information;
an angle-of-field setting unit configured to set an angle of field of a display screen of the display unit to a first angle of field or a second angle of field narrower than the first angle of field; and
an angle-of-field control section configured to cause the angle-of-field setting unit to operate according to a processing state of the apparatus and set the angle of field of the display screen of the display unit to the first angle of field or the second angle of field.

2. The apparatus according to claim 1, wherein the angle-of-field control section causes the angle-of-field setting unit to operate and set the angle of field of the display screen of the display unit to the second angle of field when personal information is displayed on the display unit.

3. The apparatus according to claim 2, wherein the angle-of-field control section causes the angle-of-field setting unit to operate and set the angle of field of the display screen of the display unit to the first angle of field when the display of the personal information on the display unit ends.

4. The apparatus according to claim 3, wherein the display unit displays predetermined commercial information when the angle of field of the display screen of the display unit is set to the first angle of field.

5. The apparatus according to claim 1, further comprising an input unit including various operation keys, wherein
the angle-of-field control section causes the angle-of-field setting unit to operate and set the angle of field of the display screen of the display unit to the second angle of field when a specific operation key involving display of personal information according to operation thereof among the operation keys included in the input unit is operated.

6. The apparatus according to claim 5, wherein the angle-of-field control section causes the angle-of-field setting unit to operate and set the angle of field of the display screen of the display unit to the first angle of field when a series of processing involved in the operation of the specific operation key is completed.

7. The apparatus according to claim 1, further comprising a card reading unit configured to read a card, wherein
the angle-of-field control section causes the angle-of-field setting unit to operate and set the angle of field of the display screen of the display unit to the second angle of field when the card is read by the card reading unit.

8. The apparatus according to claim 7, wherein the angle-of-field control section causes the angle-of-field setting unit to operate and set the angle of field of the display screen of the display unit to the first angle of field when a series of processing involved in the reading of the card by the card reading unit is completed.

9. The apparatus according to claim 1, wherein a touch panel is provided on the display screen of the display unit.

10. The apparatus according to claim 9, wherein the angle-of-field setting unit is provided further on an inner side of the display unit than the touch panel.

11. A commodity sales data processing apparatus comprising:
an operator side display unit configured to display various kinds of information to an operator;
a customer side display unit configured to display various kinds of information to a customer;
an angle-of-field setting unit configured to set angles of field of display screens of the operator side display unit and the customer side display unit to a first angle of field or a second angle of field narrower than the first angle of field; and
an angle-of-field control section configured to cause the angle-of-field setting unit to operate according to a processing state of the apparatus and set the angles of field of the display screens of the operator side display unit and the customer side display unit to the first angle of field or the second angle of field.

12. A control method for a commodity sales data processing apparatus including a display unit configured to display various kinds of information and an angle-of-field setting unit configured to set an angle of field of a display screen of the display unit to a first angle of field or a second angle of field narrower than the first angle of field, the method comprising:
specifying a processing state of the commodity sales data processing apparatus; and
causing the angle-of-field setting unit to operate according to the specified processing state and set the angle of field of the display screen of the display unit to the first angle of field or the second angle of field.

13. The method according to claim 12, wherein the processing state is presence or absence of display of personal information on the display unit.

14. The method according to claim 12, wherein the processing state is whether processing started according to reading of a card by a card reading unit configured to read the card is executed.
